(19) United States
(12) Patent Application Publication
(10) Pub. No.: US 2002/0113784 A1
(43) Pub. Date: Aug. 22, 2002

(54) Portable computer aided design apparatus and method

(76) Inventors: Michael Leon Feilmeier, Johnston, IA (US); Charles Dean Brandt, Merriam, KS (US); Eric Lee Brandt, Des Moines, IA (US)

Correspondence Address: RADER, FISHMAN & GRAUER PLLC, The Lion Building, Suite 501, 1233 20th Street, N.W., Washington, DC, 20036, US

(21) Appl. No.: 10/039,175

(22) Filed: Dec. 31, 2001

Related U.S. Application Data
(60) Provisional application No. 60/258,600, filed on Dec. 29, 2000.

(51) Int. Cl. G06T 15/00

(52) U.S. Cl. 345/419

(57) ABSTRACT

A portable computer with a touch sensitive screen includes computer aided design (CAD) software that complements CAD software on a main computer. Drawings from the main computer can be downloaded onto the portable computer, modified remotely, and then uploaded back to the main computer to reflect the drawing changes. In one embodiment, the device records data only when the user lifts a stylus from a touch sensitive screen, allowing the device to be used in physically unstable environments.

### REFERENCE TO RELATED APPLICATIONS

This application claims the benefit of commonly assigned U.S. Provisional Appln. No. 60/258,600, filed Dec. 29, 2000, the disclosure of which is incorporated herein by reference in its entirety. This application is also related to the following previously filed, commonly assigned U.S. utility applications: U.S. Appln. No. 09/532,110; U.S. Appln. No. 09/532,099; U.S. Appln No. 09/532,026 to Hedges et al.; and provisional application no 60/219,134 to Barrientos et al., all of which are assigned to the assignee of this application and are incorporated herein by reference.

### TECHNICAL FIELD

This invention relates in general to the field of virtual object representation. More specifically, the invention relates to a portable apparatus and method for computer aided design.

### BACKGROUND OF THE INVENTION

Hand held computer devices, or personal digital assistants (PDAs) are increasingly popular for many workplace applications beyond schedule organization. Users can enter and manipulate data by touching a stylus onto a touch sensitive screen. Entering data when the pen contacts the screen, however, makes data entry difficult when the PDA is used in unstable physical environments, such as while in an airplane or moving vehicle. Graphic applications for PDAs that allow a user to locate points on a map or create drawings can be particularly sensitive to unstable environments because errant physical movements may place points at a wrong location. Further, relying solely on data entry via the pen makes single-handed data review and control difficult.

There is a need for a system and method that provides a more stable, convenient way to select and capture data.

### SUMMARY OF THE INVENTION

Accordingly, the present invention is directed to a portable computing device, comprising a user interface having a touch-sensitive display that detects contact between an input device and the display, a processor, and a memory that stores a data selection, wherein the processor detects a position of the input device when the input device is removed from the display and stores the data selection corresponding to the position in memory.

The invention is also directed to a computer aided design (CAD) system, comprising a main computer that runs a desktop CAD program, at least one portable computing device that runs a portable CAD program, and a communication link between the main computer and the at least one portable computing device, wherein the portable CAD program and the desktop CAD program are complementary to allow data to be exchanged between the main computer and the portable computing device.

The invention is further directed to a method for entering data on a portable computing device having a memory, a processor, and touch-sensitive screen, the method comprising the steps of detecting the placement of an input device on the screen and saving data corresponding to a position of the input device when the input device is lifted from the screen.

### BRIEF DESCRIPTION OF THE DRAWINGS

FIG. 1 is a representative diagram of a portable device according to one embodiment of the invention;

FIG. 2 is a block diagram illustrating one method of entering data according to the invention;

FIG. 3a is a block diagram illustrating an overall system implementing one embodiment of the invention;

FIG. 3b is a block diagram illustrating one embodiment of the inventive method;

FIG. 4 illustrates a display screen displaying various functional tools according to one embodiment of the invention;

FIG. 5 illustrates another display screen for data entry according to one embodiment of the invention;

FIG. 6 illustrates another display screen for data entry according to one embodiment of the invention;

FIG. 7 illustrates a possible display for a Set First Point dialogue box according to one embodiment of the invention;

FIG. 8 illustrates a possible display for a Pick Points dialogue box according to one embodiment of the invention;

FIG. 9 illustrates a possible display for a dialogue box setting a line angle and distance according to one embodiment of the invention;

FIG. 10 illustrates a possible display for an Absolute X/Y dialogue box according to one embodiment of the invention;

FIG. 11 illustrates a possible display for a Text Designer dialogue box according to one embodiment of the invention;

FIG. 12 illustrates a possible display for a Layer dialogue box according to one embodiment of the invention;

FIG. 13 illustrates a possible display for an Insert Block dialogue box according to one embodiment of the invention;

FIG. 14 illustrates a possible display for a File Open dialogue box according to one embodiment of the invention;

FIG. 15 illustrates a possible display for a Make Block dialogue box according to one embodiment of the invention;

FIG. 16 illustrates a possible display for a Write Block dialogue box according to one embodiment of the invention;

FIG. 17 illustrates a possible display for a Save As dialogue box according to one embodiment of the invention;

FIG. 18 illustrates a possible display for a Property dialogue box according to one embodiment of the invention;

FIG. 19 illustrates a possible display for a Rotation Angle dialogue box according to one embodiment of the invention;

FIG. 20 illustrates a possible display for an Offset Distance dialogue box according to one embodiment of the invention;

FIG. 21 illustrates a possible display for an Object Properties dialogue box according to one embodiment of the invention.

### DETAILED DESCRIPTION OF THE EMBODIMENTS

System Overview

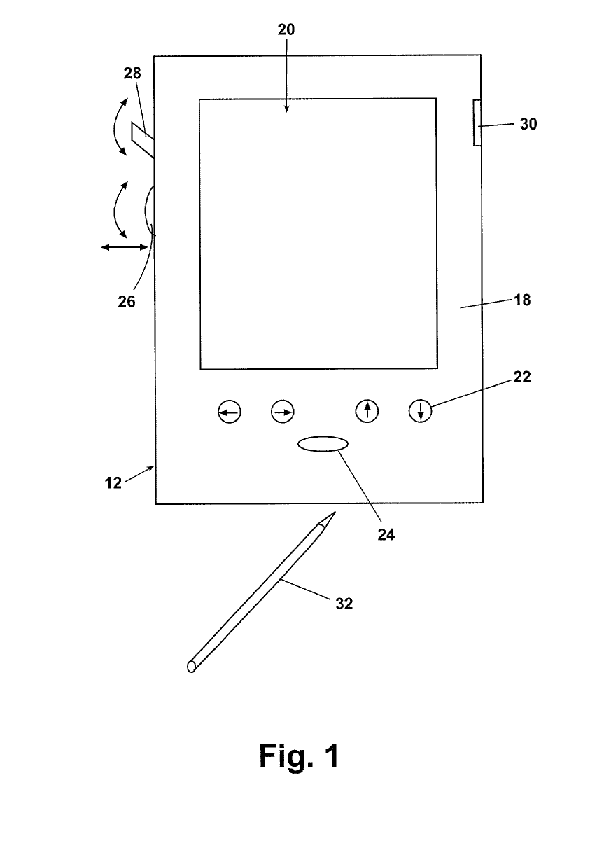

FIG. 1 illustrates one possible embodiment of a portable computing device 10, such as a PDA, according to the invention. The device 10 includes a housing 12 that holds a memory and a processor (not shown), which can be any memory and processor known in the art. The outer surface 18 of the housing 12 frames a touch sensitive screen 20, a plurality of directional buttons 22, a center zoom button 24, a rotary switch, such as a thumbwheel 26, a rocker arm 28, and a communication port 30. Data entry through the touch sensitive screen 20 can be conducted with a stylus 32, a finger, or any other object. Note that the buttons 22, 24, the rotary switch 26 and rocker arm 28 are all optional features of the PDA 10.

In one preferred embodiment, the rocker arm 28 has both a push-button switch motion as well as a rocking, rotary motion. This dual motion allows the user to, for example, switch between two display modes by pressing the rocker arm 28 inward or cycle between multiple display modes by repeatedly pulling the rocker arm 28 downward along its rotary axis. The thumbwheel 26 can allow a user to scroll up and down a display page that may be too large to fit on one screen. As can be seen from the Figure, the thumbwheel 26 and rocker arm 28 allow the user to control the viewing area and other display options with one hand and without requiring the user to touch the screen 20 using the other hand.

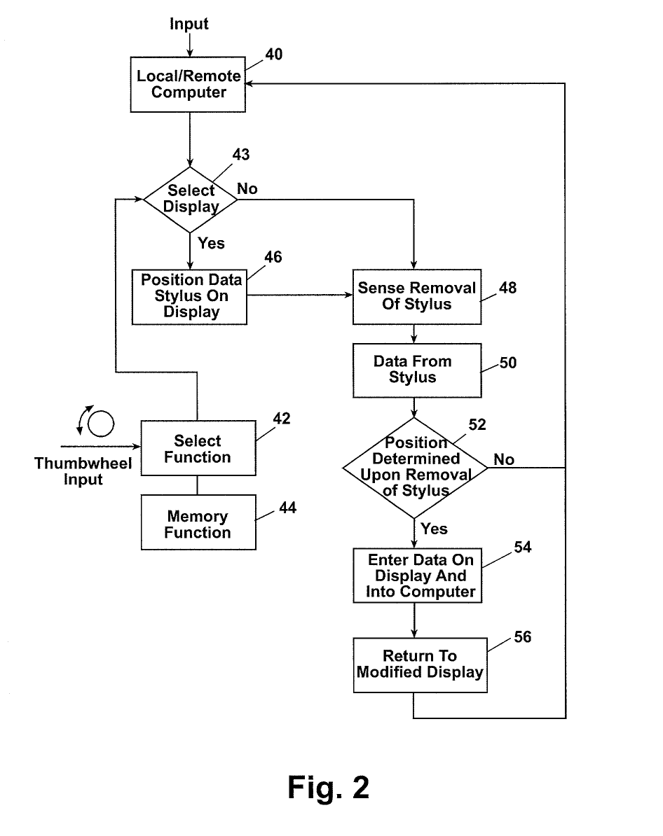

Referring to FIG. 2, the communication port 30 allows an user to download local data 34 from a personal computer (PC) 36 to the device memory. The communication port 30 may be any data connection, such as a direct cable, wireless connection, infrared port, USB port, cradle, etc. Once the local data 34 is stored in the device memory, the user can make alterations to the local data 34 on the device 10. The local data 34 is altered through the movement 50 of the stylus 32 on the touch sensitive screen 20. The movement 50 creates remote data 38 that is processed by the processor 16 that is then saved in the device memory. Features, modes, and tool settings 104a-104kk that are stored the device memory may be changed and selected by data entering means comprising the plurality of direction buttons 22, center zoom button 24, the 4-position rotary switch 26, the rocker arm 28, or through the movement of the stylus 32 on the touch sensitive screen 20.

A user can also enter and manipulate data via the touch screen 20. The invention provides a “drag and drop” functionality by capturing data only after the user lifts the stylus 32 away from the screen as opposed to when the stylus 32 is first placed in contact with the screen. FIG. 2 illustrates one way in which data can be entered via the touch screen 20 according to the inventive place/move/lift method. Generally, the inventive process involves the user placing the pen on the screen to, for example, enter a line's starting point or select an item to be moved on the screen, moving the pen to a desired location, and then lifting the pen from the screen to capture the data, such as the line's endpoint or an item's new location. This placing, moving and lifting action gives the user more control over locating points on the screen, particularly when the physical environment is unstable.

FIG. 2 illustrates one embodiment of the inventive method for entering data in more detail. In this particular embodiment, CAD data is downloaded to the device 10 from a host computer at block 40, such as a PC (not shown), so that the data can be modified off-site on the portable device 10. Of course, the device 10 can take advantage of the inventive functionalities without requiring an initial data download from another source, nor does the device 10 need to go through every block shown in FIG. 2 to fall within the scope of the invention.

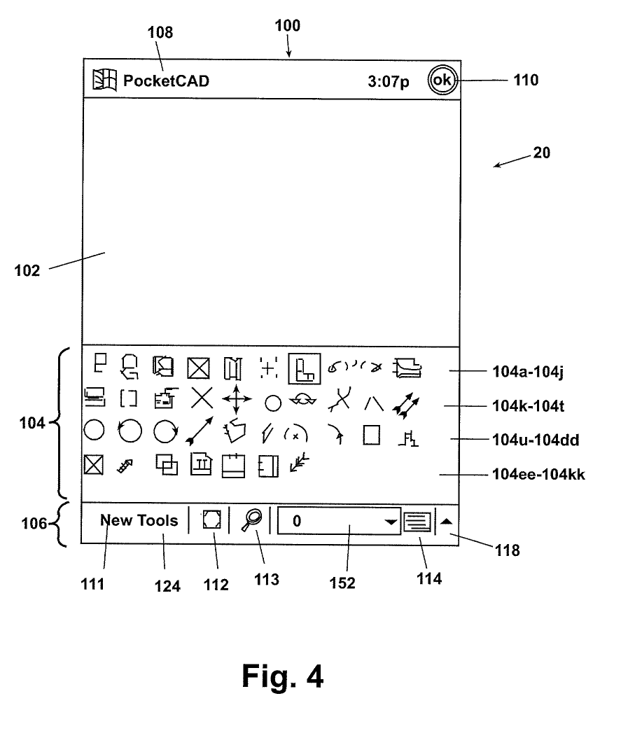

After the data is downloaded to the device memory, the thumbwheel 26, rocker arm 28, and or stylus 32 may be used to select a function at block 42, such as a memory function 44, and a display mode at block 43 provided by, for example, computer aided design (CAD) software. Examples of possible functions are shown in FIGS. 4 through 21 and will be explained in greater detail below.

Once the user selects a function and display mode 42, 43, the user places the pen on the touch screen 20 at block 46 to select, for example, a position or an item on the screen 20. As long as the pen remains on the screen 20, the device memory 14 will not capture any data even if the pen's position on the screen changes.

When the user determines that the pen is at a desired position, the user lifts the stylus 32 from the screen 20 surface. The device 10 senses the removal of the stylus 32 from the screen at block 48, the data indicated by the stylus 32′ position immediately before removal at block 50 and the last location of the stylus 32 before removal at block 52. Note that if the pen is used to select the display mode at block 43, the same place/move/lift data entry method determines which display mode is selected.

If at block 52 the device 10 is configured to save data only upon removal of the stylus 32 from the screen 20 (as opposed to when the stylus 32 touches the screen 20) the device 10 saves the data indicated by the stylus 32′ position upon removal at block 54, modifies the display to reflect the new data, and returns the user to the modified display at block 56.

The place/move/lift data entry process shown in FIG. 2 provides the user with more control over data point placement on the screen 20 even when the physical environment is not stable, such as field operations and factory floor locations.

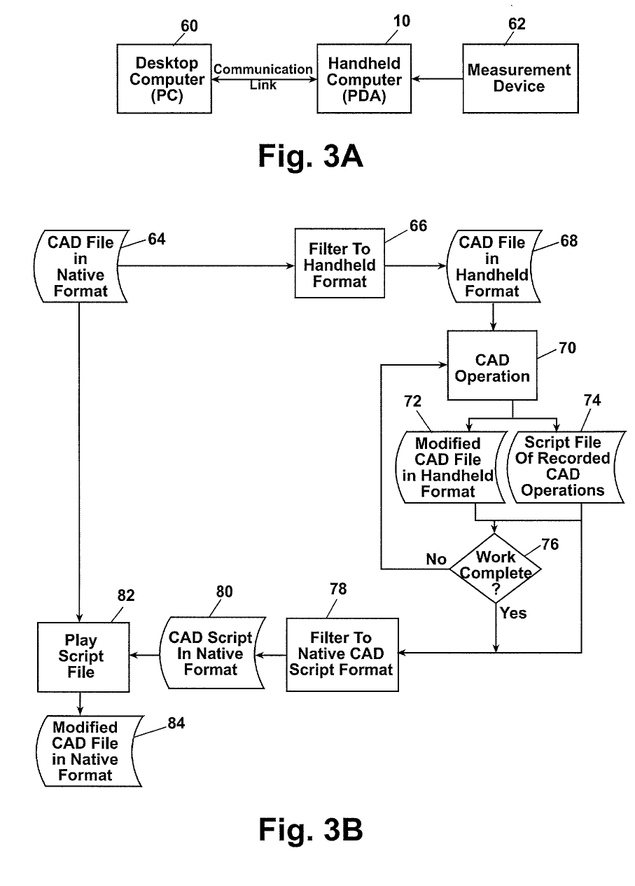

FIGS. 3a and 3b illustrates one example of an application incorporating the inventive device and method. Referring to FIG. 3a, the device 10 acts as a portable CAD tool for viewing, modifying, creating, or adding data to original CAD drawings while away from a desktop computer 60, such as while the user is on a project site, in the field or on a manufacturing floor. The portable device 10 allows the user to input data obtained from any appropriate measurement device 62 electronically without having to return to the PC 60 to enter the data. The specific measurement device 62 can vary depending on the application; for example, the human eye may be a sufficient measurement device in a facade inspection using the original CAD drawing from the PC 60 as a data collection map. In another application, a micrometer may be used as the measurement device 62 to, for example, verify measurement data on the original CAD drawing. Original CAD drawings may also be modified or even created anew by inputting the measurement data from the measurement device 62, such as a 3D measurement device, into the portable device 10.

FIG. 3b illustrates one possible method for using the inventive device 10 and method in a CAD application. In this example, a copy of an original CAD file in a native format at block 64 is downloaded from a host computer, such as a PC, through a filter that converts the CAD file's native format to the portable device's format at block 66. The converted file is then stored in the device memory at block 68 for later modification by the user. In one embodiment, the original CAD file remains in the host computer and is only updated, not changed, to prevent lost data problems.

When the user wishes to modify the CAD file by, for example, marking changes on the field or verifying measurements, the CAD operation at block 70 constitutes any operation that modifies the CAD drawing such as the place/move/lift process described above with respect to FIG. 2 or data entry from another measurement device. Each change modifies the converted CAD file stored in the device 10 at block 72 so the user can see the changes made. Further, each change is recorded in a script file at block 74. The script file records each change to the CAD file in real time. After each change, the user determines whether any more changes need to be made at block 76. If yes, the converted CAD file and the script file continue to reflect changes made by the user until the user's work is complete.

Once all the desired changes have been recorded, the script file from the portable device 10 is filtered at block 78 to convert the script file from the portable device format into the native format of the original CAD file, resulting in a CAD script in the native format at block 80. The original CAD file from block 304 and the converted CAD script from block 70, both in the native format, are then combined by playing the script file against the original CAD file at block 72. This step can be carried out in the PC 60. Because the script file lists all of the changes made to the original CAD file, playing the script file against the original CAD file generates a modified CAD file in the native format at block 84. The modified CAD file reflects all of the changes made via the portable device 10, allowing the user to change a CAD file without the PC 60.

As a result, the invention retains the original CAD file information while still allowing modifications through the portable device 10. Further, the filtering operations at blocks 66 and 68 allow the invention to be used with CAD products from multiple vendors. The CAD system used in the portable device 10 is subordinate to the CAD software used by the PC 60, allowing the device 10 to not only modify CAD files remotely, but also to interface with any CAD software regardless of the software's specific vendor. Also, because the device 10 saves the modifications in a script file that is independent of the original CAD file's native format, the invention allows data to be collected from multiple devices 10 and stored in a central database on the PC 60.

Note that the specific steps in carrying out the file transfer process can vary from the steps shown in FIG. 3b without departing from the scope of the invention. As long as the process can move files between the host computer 60 and the mobile device 10 and merge changes made in mobile device 10 into the corresponding file in the host computer 60, it falls within the invention's scope.

Portable CAD System Description

FIGS. 4 through 21 illustrate one specific application that can be implemented with the inventive device 10. The application is a CAD program that takes advantage of the inventive functions provided by the invention. Note that the description below and the corresponding figures illustrate only one possible embodiment and that the items and any of the functions described below can be omitted, modified, or combined in different ways without departing from the scope of the invention.

To allow users to create CAD drawings directly on the portable device, the invention may include a Pick Points features and a Set Points feature. The Pick Points feature allows a user to quickly obtain an item shown on the display 20 by dragging the stylus 32 on the display until it nears a displayed item. If the Pick Points feature is turned on, a cursor controlled by the stylus 32 position will automatically snap to the entity closest to the stylus 32 point.

The Set Points feature allows a user to specify exact point coordinates in a drawing either with respect to an absolute coordinate system or a relative coordinate system. For example, if the user wishes to place a selected item on the screen an exact distance and direction away from a chosen base point, the Set Points feature can obtain the distance and direction information (e.g., in X-Y coordinates or in polar coordinates) and move the selected item automatically on the screen, without relying on the user to move the item manually with the stylus 32.

Data Entry and Capture

Referring to FIG. 4, the CAD program provides a plurality of tool settings 100a-100kk for modifying a CAD drawing. As noted above, the thumbwheel 26 can allow the user to cycle through various drawing tools, block tools, editing tools, and inquiry tools 104a-104kk. Further, the rocker arm 28 can be used to select a pan or zoom mode to view different parts or enlarge a specific area of a CAD drawing 34. The tools 104a-104kk provide enough functions to allow the user to view and alter a CAD drawing 34 using the portable device 10 rather than the PC 60.

The touch sensitive screen 20 according to one embodiment includes a header bar 100, drawing window 102, toolbar 104 containing tools 100a-100kk, and display bar 106. The header bar 100 includes a start button 108 to view program options as well as an OK button 110 to access File Open and Save options. The toolbar 104 is used in conjunction with the drawing window 102 so that the use may enter CAD data and/or modify CAD drawings on the remote device 10 rather than the PC 300. The toolbar 104 may include a “pop-up” feature that optimizes window space, particularly in view of the small screens offered by portable devices.

The toolbar 104 in this example includes tools such as a Pan 104a, Zoom Previous 104b, Zoom Window 104c, Zoom Extents 104d, Pick Points 104e, Set Points 104f, Measure 104g, Undo 104h, Redo 104i, Layers 104j, Change Layer 104k, Select 104l, Object Property Page 104m, Delete 104n, Move 104o, Copy 104p, Rotate 104q, Trim 104r, Extend 104s, Offset 104t, Circle with Center Point 104u, Circle with Two Points 104v, Circle with Three Points 104w, Line 104x, Polyline 104y, Sketch 104z, Arc with Center 104aa, Arc with Three Points 104bb, Rectangle 104cc, Text 104dd, Insert Block 104ee, Explode 104ff, Make Block 104gg, Write Block 104hh, Horizontal Dimensions 104ii, Vertical Dimensions 104jj, and Aligned Dimensions 104kk. Not all of these tools need to be incorporated into the inventive CAD program, nor are the possible tools limited to these examples.

An Autohide feature allows the user to display and hide the toolbar 404. To operate this feature, the user can touch the Show/Hide button 412 in the display bar 106 with the stylus 32 to make the toolbar 104 appear on the display. Touching the Show/Hide button 112 again hides the toolbar 104 from view. The New button 111 in the display bar 106 clears the window 102 and opens a new drawing. In this embodiment, pressing the thumbwheel 26 inward in a linear motion allows the user to selectively choose between data entry using the stylus 32 and screen 20 and using the direction buttons 22, center zoom button 24, thumbwheel 26, and rocker arm 28 (FIG. 1).

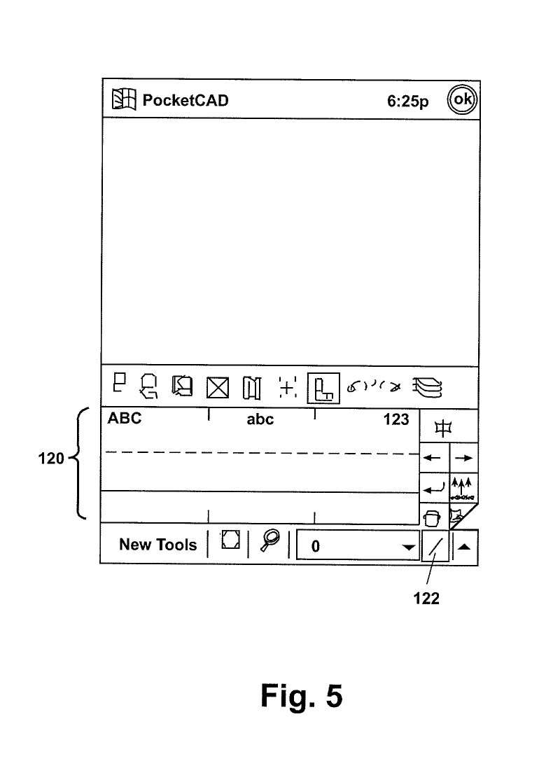

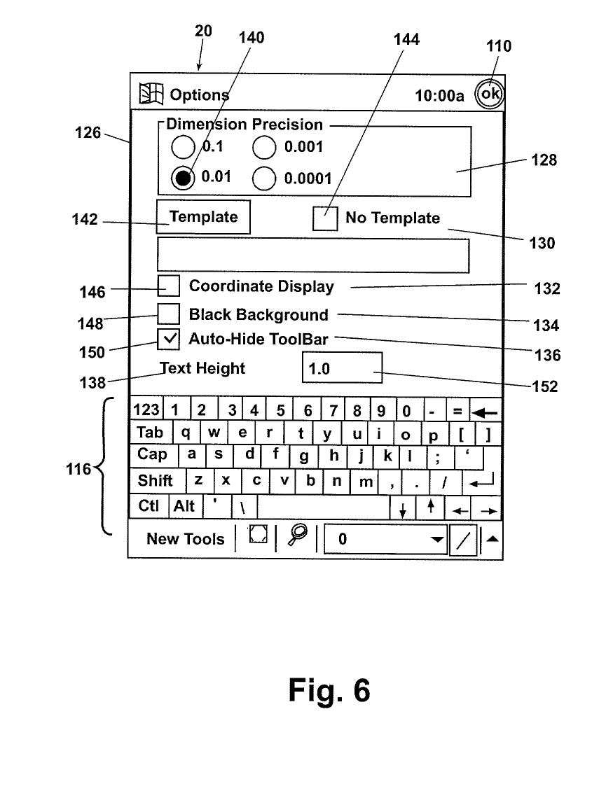

The display bar 106 also includes an alphanumeric keypad button 114 that opens an alphanumeric keypad 116 (FIG. 6) when selected via the stylus 32. The stylus 32 may be used to select letters and numbers from the keypad 116. If the user selects the arrow 118 next to the keypad button 114, a shortcut menu 120 (FIG. 5) appears and the user has the option to select a character recognition mode. Character recognition software in this mode allows the user to enter data by writing on the screen 20 instead of using the keypad.

Selecting the Tools button 124 in FIG. 4 allows the user to select among three menu options: About, Options, and Exit. The About menu (not shown) shows the user the vendor and version information of the device 10. The Exit menu (not shown) permits the user to quit the application. The Options menu displays an Options dialog box 126 (FIG. 6) for setting selected preference settings.

The preference settings include: Set Dimensions Precision 128, Set Template/No Template 130, Coordinate Display 132, Set Black Background 134, Set Auto-hide Toolbar 136, and Set Text Height 138. Selecting the OK button 110 in the header bar saves the selected preference settings, which will be applied to all subsequent drawing sessions.

Set Dimensions Precision 128 is set by selecting one of multiple buttons 140. Set Dimensions Precision sets the number of decimal places to display for linear units in dimensioning.

Set Template/No Template 130 is set by selecting the Template button 142, which opens a File Open dialogue box. The user may browse files and select one to be used as a template. After the user selects a template, the screen 20 returns to the Preferences dialogue box with a template drawing. If a template drawing is not needed, selecting the No Template checkbox 144 will clear the template file. Any drawing may be used as a template for creating new drawings. Changes that are made to the new drawing will not affect the template.

Coordinate Display 132 is set by selecting the Coordinate Display box 146. This feature is useful when drawing and editing an entity on the display 20 when the stylus 32 is being moved over a drawing that is too large to fit on one screen. In this mode, the display automatically shifts as the stylus 32 approaches an edge or corner of the display 20. This prevents the edge of the display from interfering with the drawing movement of the stylus 32. When left unchecked, the coordinate display box 146 is not visible.

Set Black Background 134 is set by clicking the checkbox 148 if the user wants a black background color for the display 20. If the box 148 is left unchecked, the display background color 20 will be white.

Set Autohide Toolbar 136 is set by clicking the checkbox 150 if the user wants the toolbar 104 to be hidden. Leaving the box 150 unchecked will display the toolbar 104 on the display 20.

Set Text Height 138 allows the user to type a number in the text box 152 in order to change the text height.

Referring back to FIG. 4, the inventive CAD software offers four groups of operating tools in the toolbar 104: Drawing Tools (104e, 104f, 104j, 104p, 104u-104dd, 104ii, 104kk), Block Tools (104dd, 104ee, 104gg, 104hh), Editing Tools (104f, 104h-104t, 104ff), and Inquiry Tools (104a-104d, 104g, 104jj). Some operating tools can perform more than one function. Many of the tool buttons also provide access to associated dialog boxes where the user can select or edit various parameters using the stylus 32. Each operating tool group is described in greater detail below.

Drawing Tools

Set Points Tool 104f:

The Set Points Tool sets up a drawing by requesting the user to enter in a dialogue box the Cartesian “X and Y” components of a selected point or data corresponding to a specific distance and direction (e.g. angle) from a base point. The base point is the last point of the last drawn entity. If a line is drawn last, the end point of the line will be the base point. If a circle is drawn last, the center of the circle will be the base point.

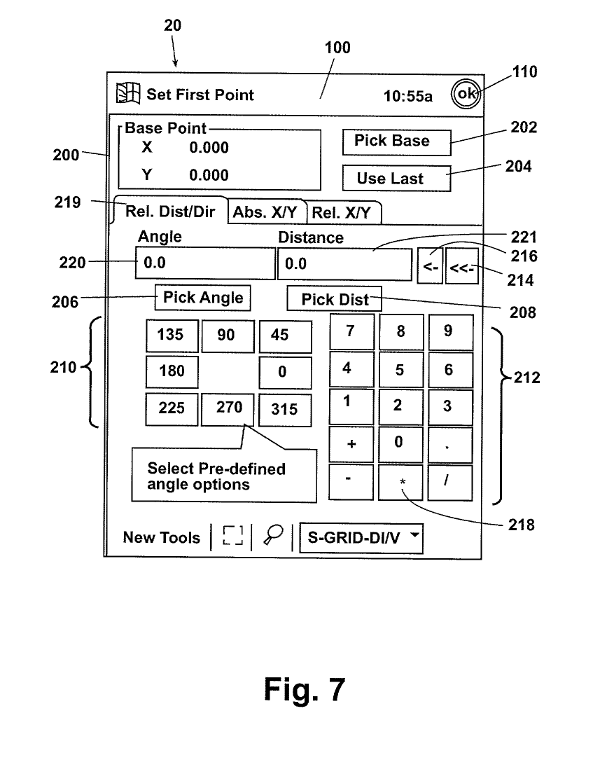

The Set Points Tool 104f tracks the drawing or editing process and displays the point it is currently setting in a title bar in the dialogue box. As shown in FIG. 7, the Set First Point dialogue box 200, showing the Relative Distance/Direction tab 219, also includes the following button: Pick Base 202, Use Last 204, Pick Angle 206, Pick Distance 208, Pick a Predefined Angle 210, Number Pad 212, Reset 214, Backspace 216, and Foot 218.

The Pick Base function 202 closes the dialogue box 200 and allows the user to select a point from the touch sensitive screen, making it easier to locate a specific, visual point without relying on entered X-Y coordinates.

The Use Last button 204 allows the user to select the Pick Base button 202 while also using the previously selected point on the window 102.

The Pick Angle Button 206 closes the dialogue box 200 and allows the user to specify an angle by picking two points from the window 102.

The Pick Distance button 208 closes the dialogue box 200 and allows the user to specify a distance by picking two points from the window 102.

The Pick a Predefined Angle button 210 allows the user to pick a desired angle that may be entered in an angle text box 220. A palette of commonly used angles 210 may be included for the user's convenience.

The Number Pad 212 allows the user to easily use the stylus 32 to enter a numeric value. The Number Pad 212 may also be used with the Pick Angle 206 and Pick Distance buttons 208.

The Reset button 214 sets the value of the angle and distance text boxes back to 0.0. The Backspace button 216 allows the user to use the stylus 32 to control the input. The user may click in the desired text box, then select the Backspace button 216 until the desired value is reached.

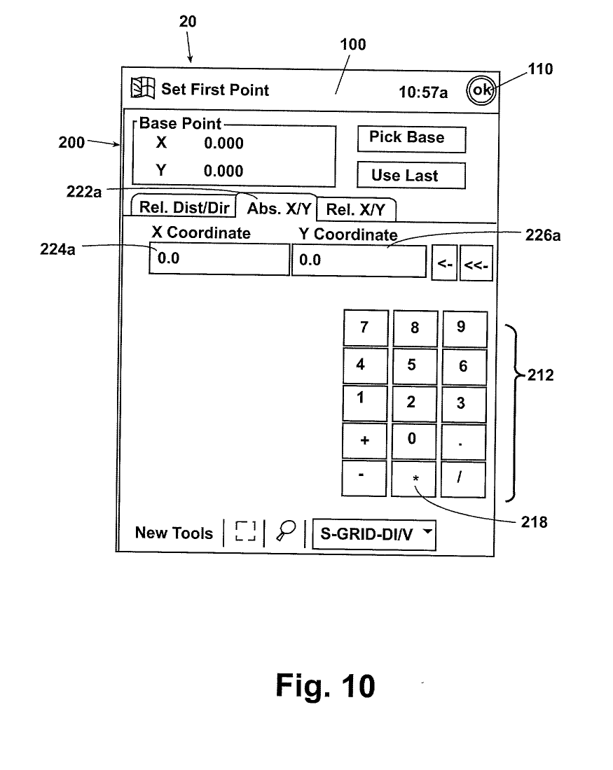

The Foot button 218 allows the user to enter values in feet and inch notations. Any number with a negative X-Y coordinate value is placed either below or to the left of the origin point (0,0). The Set First Point dialogue box also includes Absolute X/Y (FIG. 10) and Relative X/Y tabs (not shown). The Absolute X/Y function allows the user to enter X and Y coordinates with respect to the origin (0,0), regardless of the base point's location. The Relative X/Y function allows the user to enter a specific X and Y value with respect to a selected base point as opposed to the origin point.

Pick Point Tool 104e:

As noted above, the Pick Point tool allows the user to place the stylus 32 on a selected point in the window 102 and move the pen 32 near an existing item on the window 102 to automatically snap a cursor to the existing item. Selecting the Pick Points Tool 104e will open the Pick Points dialogue box 250. Pick Points can be turned on or off in the middle of a command sequence.

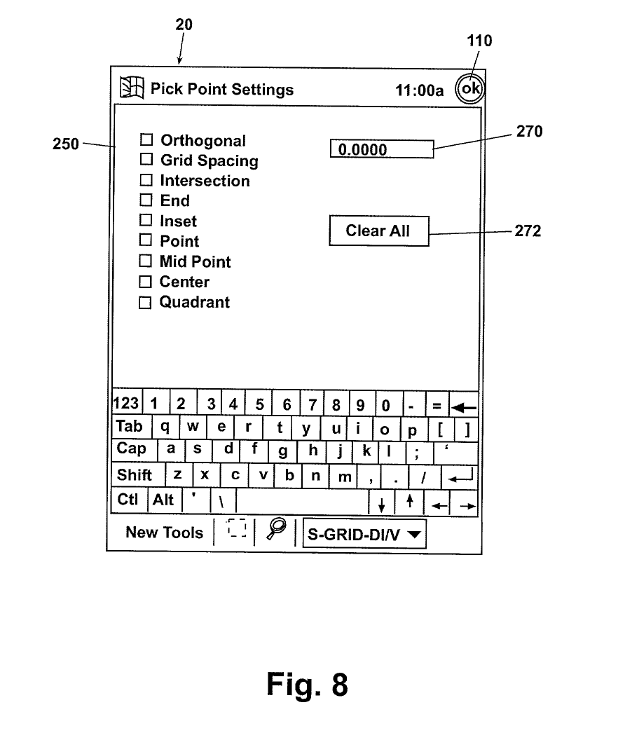

As shown in FIG. 8, the Pick Points Tool 104e allows the user may choose from the following modes shown in the dialogue box 250: Orthogonal 252, Grid Spacing 254, Intersection 256, End 258, Insert 260, Point 262, Mid Point 264, Center 266, and Quadrant 268. The different modes dictate how a cursor on the display will “snap” to a selected location for precise positioning.

The Orthogonal mode 252 constrains cursor movement to the horizontal and/or vertical directions.

The Grid Spacing mode 254 restricts cursor movement to specified intervals along a grid. More particularly, the points that the user picks with the stylus 32 are locked into alignment based on the value set in the Spacing text box 270. In one embodiment, a change in the grid affects only the coordinates of points entered after the change; objects already existing in the drawing 34 retain their existing coordinates. The grid itself can be invisible to keep the display window_easy to view.

The Intersection mode 256 snaps the cursor to the point at which displayed objects, such as lines, arcs, circles and polylines, overlap. The End mode 258 snaps to the closest end point of a displayed object. The Insert mode 260 snaps to the base or insertion point of text or a block. The Point mode 262 snaps to any defined point in the drawing. The Midpoint mode 264 snaps to the midpoint of a line. The Center mode 266 snaps to the center point of arcs and circles.

The Quadrant mode 268 snaps to the closest quadrant of an arc or circle. Quadrants can be defined as 0, 90, 180, and 270 degree positions on the arc or circle. A Clear All button 272 clears all previous settings.

Circle with Center Point and Radius Tool 104u:

The Circle with Center Point and Radius Tool 104u creates a circle by selecting a center point and a radius with the stylus 32. In one embodiment, the first selected point is the center point and the second selected point sets the radius distance. When using the Set Points dialog box 200, the center point acts as the base point.

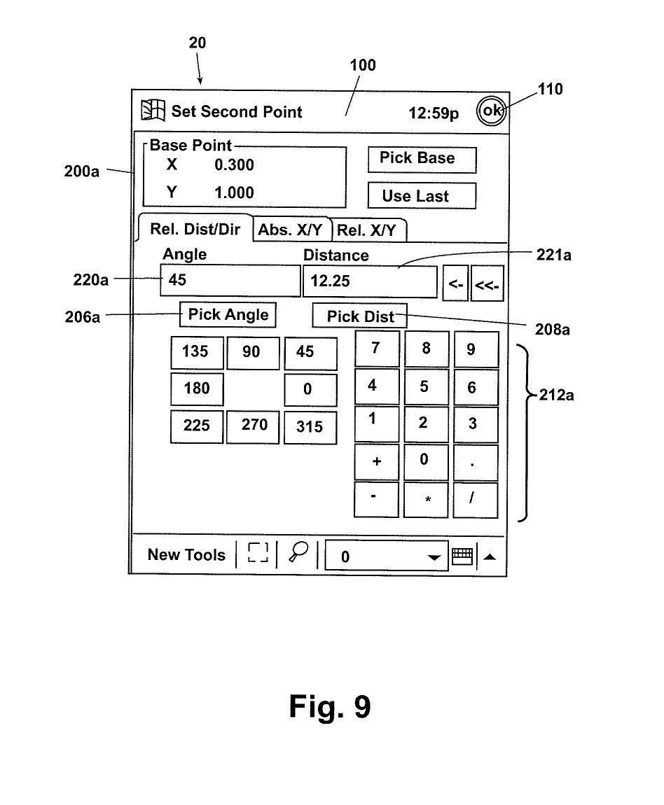

To form a circle, the user selects the Circle with Center Point and Radius tool 104u, and sets the center point using the place/move/lift action explained above, i.e., the center point is not defined until the user lifts the stylus 32 from the display 20. Next, as shown in FIG. 9, the user picks the Set Points Tool 104f, which opens the Set Second Point dialogue box 200a. The previously defined center point appears in the dialogue box window as a coordinate. The user may then set the radius by typing a specific value in the Distance text box 221a. This will generate a circle having the selected radius and center point. Concentric circles may be drawn by repeating the steps shown above, selecting the same center point but entering different radius values.

Circle with Two Points Tool 104v:

This tool creates a circle using two points to define the circle's diameter. The user first selects the Circle with Two Points Tool 104v, then places, moves, and lifts the stylus 32 two times to define two distance points on the window 102. The distance between the two points is the diameter of the circle to be drawn. If additional circles will be drawn, the last point entered will be considered the center point for the new circle.

Circle with Three Points Tool 104w:

This tool creates a circle by fitting a circle through three picked points. The user first selects the Circle with Three Points Tool 104w, then places, moves, and lifts the stylus 32 three times to define three points on the window 102. The program automatically defines a center point and connects the points with 3 arcs to form the circle.

Line Tool 104x:

This tool creates a straight line when the user simply specifies two endpoints. The user can also draw a line using the Set Points Tool 104f in conjunction with the Line Tool 104x by either specifying two X,Y coordinates or by picking a point on the window 102 and choosing a specific angle and distance. In this case, the user selects a first point location with the stylus 32 and then selects the Set Points Tool 104f, opening the Set Second Point dialogue box 200a. The user may then define a specific angle 220a in the angle text box. The user then enters a specific distance in the distance text box 221a with the keypad 212a. Selecting the OK button 110 in the header bar 100 will result in a line having the specified angle and distance.

Continuous lines may be created by repeating the steps explained above. When the user chooses the Set Points Tool 104f and the Set First Point dialogue box 200 opens, the last point of the last drawn line is shown as a default endpoint of the new line. Selecting the OK button 110 sets the start point of the new line at the end point of the last drawn line. Picking the Set Points Tool 104f again will open the Set Second Point dialogue box 200a. Repeating the steps shown above for the first line will result in continuous, connected line segments.

Polyline Tool 104y:

This tool connects straight-line segments. Each line segment in the polyline is treated as a single object. Polylines are created by first selecting the Polyline Tool 104y. The user picks a start point on the window 102 by placing the stylus 32 on the window 102 and lifting it without dragging it on the window 102. The user then repeats this multiple times to append line segments to form a polyline. The Pick Points Tool 104e can also be used to form a polyline as well.

Sketch Tool 104z:

This tool creates a polyline that traces the freehand movement of the stylus 32 over the window 102. When the stylus 32 pen 32 is lifted, the system creates the complete polyline, displays it and saves it in memory 14. The polyline is constructed of short line segments whose lengths are determined by the settings of the zoom factor noted above. If the zoom factor is fully engaged, the polyline sketch will create a higher resolution polyline than if it were fully disengaged, or zoomed-out.

Arc with Three Points Tool 104bb:

This tool creates an arc from three points specified by the user. After the Arc with Three Points Tool 104bb is selected, the user defines three points on the window 102 by placing, moving, and lifting the stylus 32 pen 32 three times. In one embodiment, the arc connects the points in the order in which they were entered.

Arc with Center Tool 104aa:

This tool creates an arc by specifying the center, starting point, and ending point of an arc. After the Arc with Center Tool 104aa is selected, the user defines the center, starting point, and ending point on the window 102 by placing, moving, and lifting the stylus 32 pen 32 three times. The first entered point is treated as the center point, and the second and third points are the start and end points of the arc, respectively.

Rectangle Tool 104cc:

This tool creates a rectangle by using two points to represent opposite comers of the rectangle. The user forms the rectangle by first selecting the Rectangle Tool 104cc. The user then defines the first rectangle comer point by placing, moving, and lifting the stylus 32. The user then may choose the Set Points Tool 104f, which opens the Set Second Point dialogue box 200a. As shown in FIG. 10, by selecting the Absolute X/Y tab 222a, the user may enter a specific value for the X and Y coordinates in the text boxes 224a, 226a on the number pad 212a. The second point picked is also considered the last point for the rectangle. To complete the rectangle, the user clicks on the OK button 110 in the header bar 100. As explained above, negative values may be entered, and the appropriate coordinate will be defined on the screen.

Text Tool 104dd:

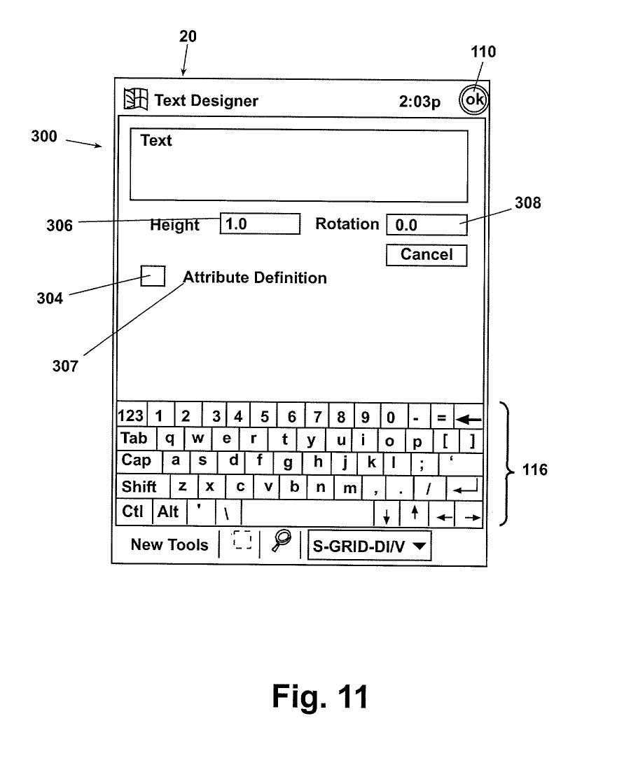

This tool creates a string of text located at a point selected by the user. The user first selects the Text Tool 104dd, then places the stylus 32 on the window 102, moves it to the area where text is desired, then lifts the pen to open the text designer dialogue box 300. As shown in FIG. 11, the dialogue box 300 allows the user to specify a string of text in the drawing. The user may also choose text height and text angle in text boxes 306 and 308 respectively. The rotation angle is referenced from the rotation around a picked point in a counter clockwise motion. The rotation angle is preset to 0 degrees and the text height remains set to the last defined height by the user.

The Text Tool 104dd also allows the user to create attribute definitions 302 for use in blocks. Attributes 302 are storage locations with blocks that allow the user to update text information without having to redefine the block. As will be explained below in the Block Tools section, the user may create text attributes in blocks by clicking in the checkbox 304.

Layers Tool 104j:

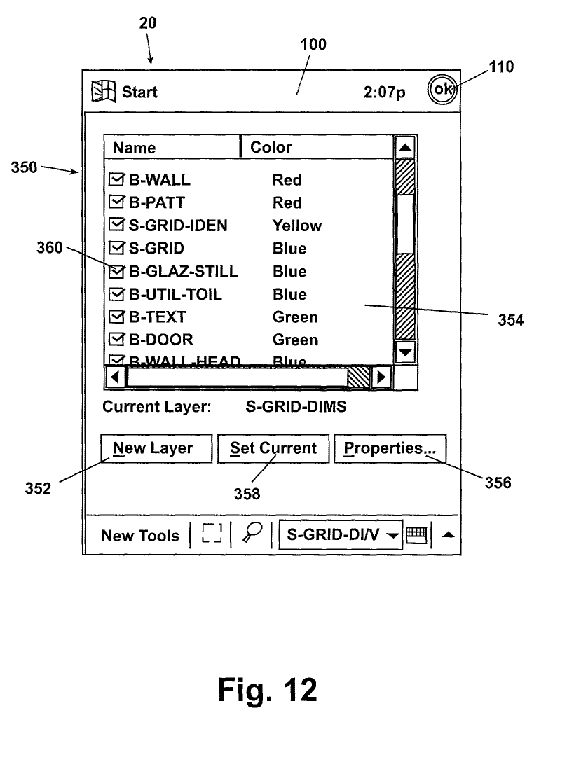

In one embodiment of the invention, a layer is defined as a grouping of drawing entities that overlay on a drawing. Layers assist the user in organizing a drawing, and the Layers Tool allows the user to select a layer on which to create a drawing. When the Layers Tool 104j is picked, the layers dialogue box 350, as shown in FIG. 12, allows the user to perform drawing setups for layers so that each layer may be edited individually. Layers can be assigned names to identify and distinguish them from other layers.

To help the user know which layer is being edited, each layer and all drawings on that layer can be assigned a different color. For example, if a given layer is assigned a red color, all items drawn on that layer will appear red on the display 20 as well. To further simplify the editing process of a multi-layered document, the system may allow the user to control which layers are displayed (ON) or not displayed (OFF).v When the layers are not being used, setting the state of the unused layers to OFF increases the performance of the device 10 by reducing the number of active layers at any one time.

Layers can be created by either using the Layer Dialogue Box 350 or the Current Layer Pull Down List 152 shown in FIG. 4. The Layer Dialogue Box 350 allows the user to add new layers and gives the user control over the layer properties. The Current Layer Pull Down List 152 is a box on the screen display bar 106 that shows the layers in the ON state at that time. The user may select a layer name from this list that allows the user to set the selected layer as the current layer.

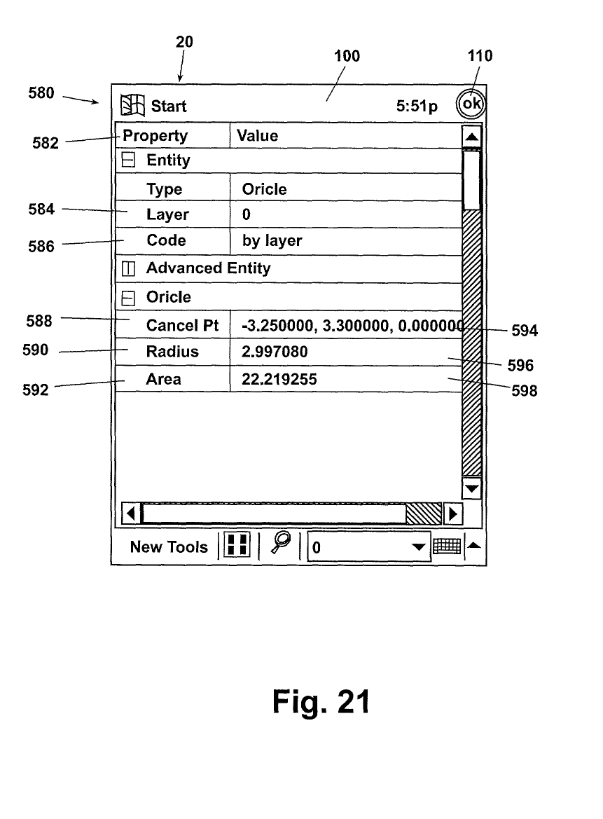

The Layer Dialogue Box 350 allows the user to create a new layer at any time. Newly created layers do not have to have drawing entities immediately after they are created; they can remain blank until the user chooses to add items to the layer. To create a layer, the user must first pick the New Layer button 352. Once the button 352 is picked, “New Layer 1” is added to the layer table 354. The name New Layer 1 increments to New Layer 2 if New Layer 1 already exists. Next, the user picks the text of the layer name 362 and then selects the Properties button 356, which opens the Properties dialogue box (FIG. 21). The user may change any property of the layer such as name 362, color 364, or state (checkbox 360). Once the user clicks the OK button 110 in the header bar 100, the new layer is created and assigned a default color.

A current layer may be set by highlighting the text of the layer name 362 that the user wishes to be the current layer and picking the Set Current button 358. A check mark or other indicator next to the name indicates the state (ON/OFF) of the layer associated with that given indicator. The ON/OFF state of the layer can be toggled between ON and OFF by, for example, touching the stylus 32 to the indicator next to the layer being toggled.

A layer's color 364 may be defined by picking the text of the layer name 362, and then selecting the Properties button 356, which opens the Properties dialogue box (FIG. 21). The dialogue box permits the user to change the layer's color 364 from any predefined color, labeled 1 through 9 in this example. If the original CAD data in the PC is generated from a CAD program that offers more than 9 colors, the device 10 will display layers with colors other than the devices 9 base colors in a default color; however, the original color number will still be retained in the drawing file so that the additional colors will appear when the CAD data is exported from the device 10 back to the PC .

Horizontal Dimensions Tool 104ii:

This tool measures and labels linear dimensions corresponding to the distance between two points parallel to the X-axis. After selecting the Horizontal Dimensions Tool 104ii, the user defines two points of measurement and then defines a third point indicating the position of the text and arrowheads labeling the horizontal dimension.

Vertical Dimensions Tool 104jj:

This tool works the same way as the Horizontal Dimensions Tool 104ii except that it is used measure and label linear dimensions between two points parallel to the Y-axis. The user first defines the two end points and then defines a third point indicating the position of the text and arrowheads labeling the vertical dimension.

Aligned Dimensions Tool 104kk:

This tool allows the linear dimensioning of the absolute distance between two points, regardless of the relative position of the distance with respect to the X and Y axes. This makes it possible to dimension spaces that not parallel to the X- or Y-axes. The Aligned Dimensions Tool works in a manner similar to the Horizontal and Vertical Dimensions Tools 104 ii, 104jj in that the user first defines the two end points of measurement and defines a third point indicating the position of the text of the dimension and arrowheads labeling aligned dimension. The absolute measurement between the two points will be inserted into the displayed drawing on an aligned plane, without reference to the X or Y axes.

Block Tools

Block tools allow the user to group and ungroup multiple items in a drawing, move the grouped items to different layers or files, and edit text in blocks. Manipulating groups of items as a single block provides the user an efficient way to make large scale changes to drawings while preserving the relationship between items in the group.

Insert Block Tool 104ee:

This tool inserts a block located at a selected point. The device 10 can insert a block located a selected point, insert blocks that are already defined in the drawing, or insert other blocks into the current drawing. The device 10 follows two rules concerning block definitions. The first rule is that if an user inserts a file with the name of a block that is already defined in the drawing, the device 10 uses the definition of the file being inserted. The second rule is that if the user has a nested block (i.e. a block inside a block) in a file that is being inserted and there is a block in the drawing with that same name, the user can redefine the existing block or the original definition rule.

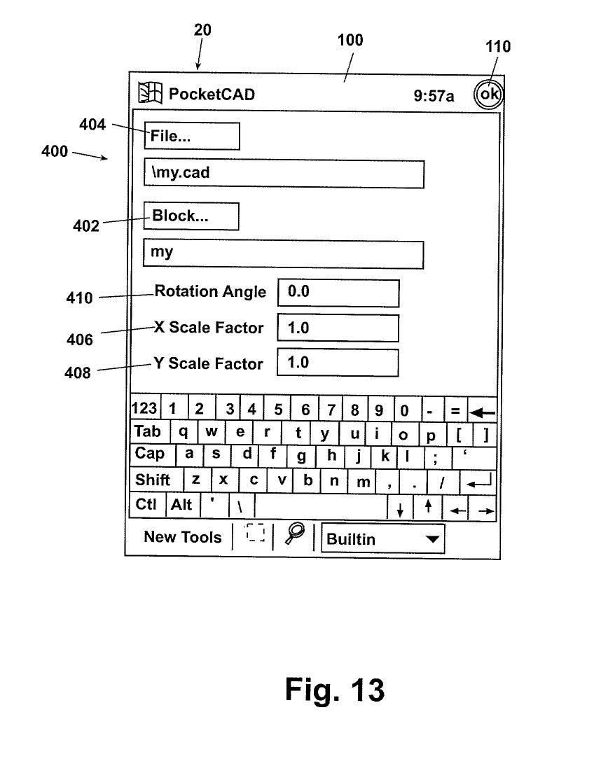

As seen in FIG. 13, to insert a block that is already defined within the current CAD file, the user must first pick the Insert Block Tool 104ee, and then click on the OK button 110 in the header bar 100, which closes the Insert Block dialogue box 400. The device 10 then waits for the user to select a point on the window 102 by placing and moving the stylus 32. Once the user lifts the pen 32, the block is inserted into the drawing. If internal blocks are defined within a drawing, the user may select the Block button 402, and a list of the blocks that are defined appears on the window 102.

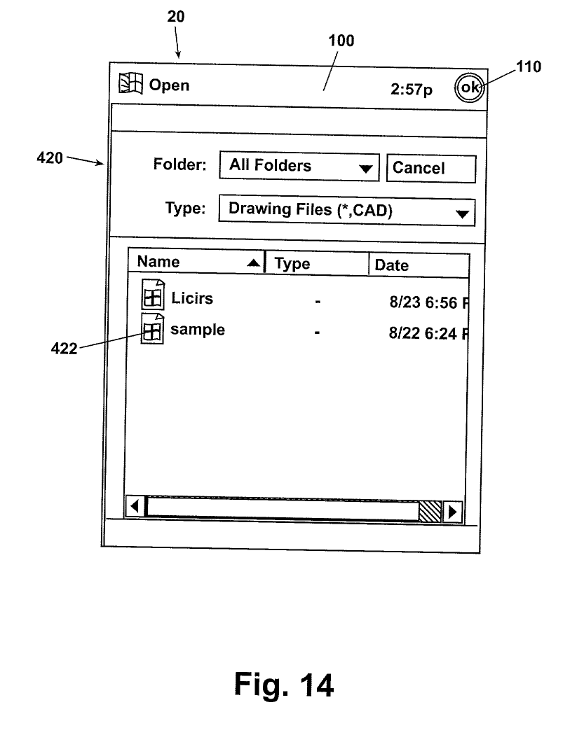

The user may insert other CAD files defining other blocks into the current drawing. To insert a CAD file that already defines a block, the user first selects the Insert Block Tool 104ee, which opens the Insert Block dialogue box 400. Selecting the File button 404 opens the standard Windows File Open dialogue box 420, shown in FIG. 14. The user may then browse through the CAD files 422 to locate the CAD file containing the block to be inserted. Once the CAD file is inserted as a block, the window 102 returns to the Insert Block dialogue box 400. The user may then set the X and Y scale factors 406, 408 and the rotation angle 410 for the inserted block.

Blocks obtained from existing CAD files and inserted into the drawing have an insertion base point of (0,0). Further, when the user inserts a CAD file into the drawing as a block, the path of the file is recorded in the memory 14. The directory then becomes the default directory where user obtains symbols for the drawing, if needed.

Make a Block Tool 104gg:

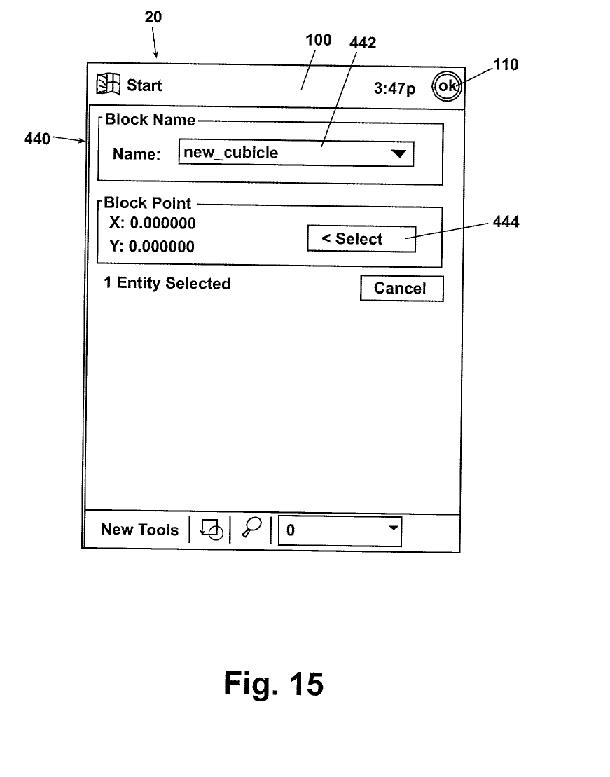

This tool creates blocks based on selected items in the current drawing. To create a block, the user selects the Select Tool 104l to highlight a group of objects that the user wants to group into a block. The user then selects the Make Block Tool 104gg, which opens the Make Block dialogue box 440, as seen in FIG. 15. The user then supplies a name 442 for the new block or may select a name of an existing internal block in order to redefine the existing block. If the user wants a block base point other than (0,0) the user may supply X,Y coordinate base points by selecting the select button 444 for an insertion point. Selecting the OK button 110 in the header bar 100 closes the dialogue box 440, leaving the Make Block Tool 104gg active, and creates a new insertion point specified on the window 102. Selecting the OK button 110 in the header bar 100 clears the individual grouped items from the window 102 to indicate that a block was created.

Write Block Tool 104hh:

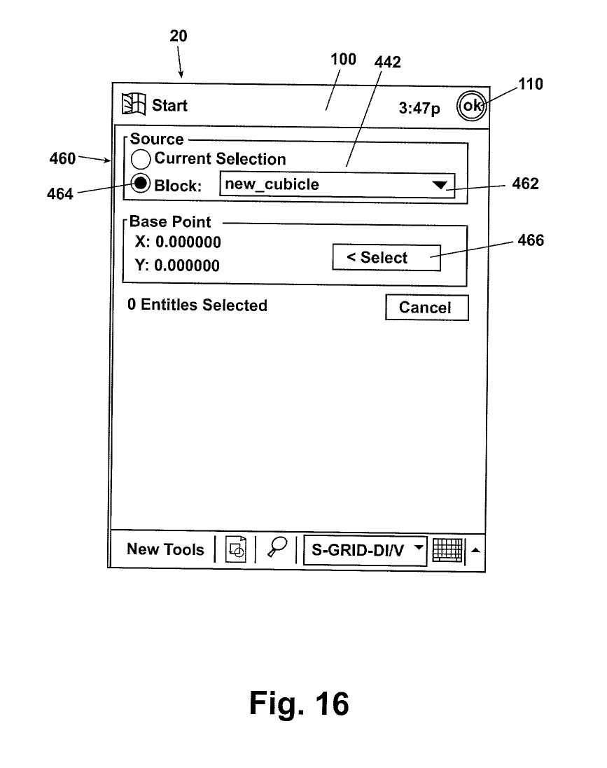

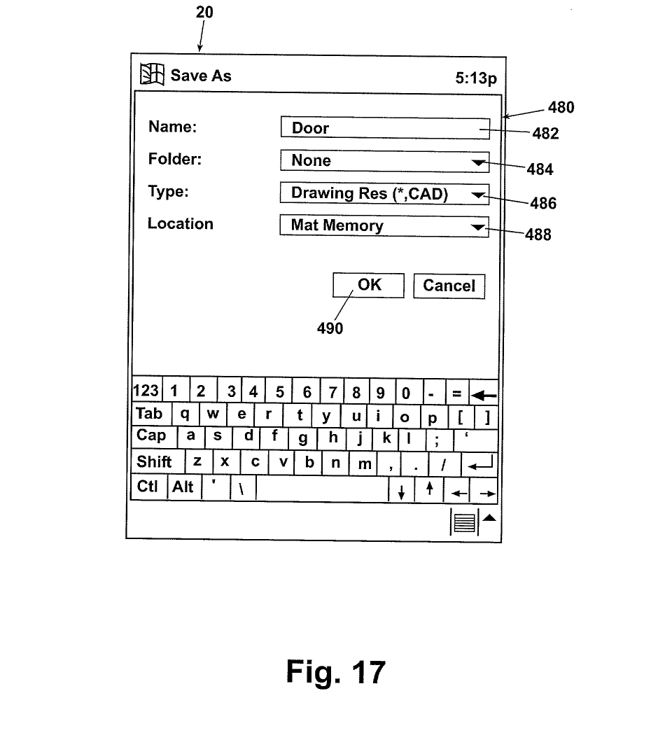

This tool creates a separate file from either an internally defined block or objects selected from the window 102. If there is nothing selected on the window 102 when the Write Block Tool 104hh is picked, the default settings force the user to pick the name of an internally defined block. However, if the user has selected objects, then the user is given the choice of using the selection or choosing the name of an internally defined block from the pull-down list 462 in the display bar in the Write Block dialogue box 460 in FIG. 16. To write out an internally defined block, the user must first clear any selection set that appears in the window 102. The user then picks the Write Block Tool 104hh, which opens the Write Block dialogue box 460. The user then may pick the desired block to write from the Block pull-down list box 462. The Save As dialogue box 480, as seen in FIG. 17, appears and displays information such as the name 482, folder 484, type 486, and location 488 about the block that the user selected. The user then clicks the OK button 490. Once the OK button 490 is clicked, the device 10 prompts the user to use the stylus 32 and choose the name 482 for the new file.

To write out a selection set of objects, the user first uses the Select Tool 104l to select desired objects for grouping into a block. Then, the user picks the Write Block Tool 104hh. The Write Block dialogue box 460 appears with the radio button 464 checked for Current Selection. If the user does not want to use (0,0) as the base point, the user may reset it at this stage. The base point may be changed by the user by picking the Select button 466 to close the Write Block page and selecting Pick Points to choose a different point as the Insertion Point. The user then choose the Make Block Tool 104gg to reinitiate the blocking process.

Once the selection set of objects is written out, the user clicks the OK button 110, and a new block is created. Selecting the OK button 110 will present the user with the Save As file dialogue box 480. The user may then supply a file name 482 and then click on the OK button 490 to create the file.

Text Tool 104dd:

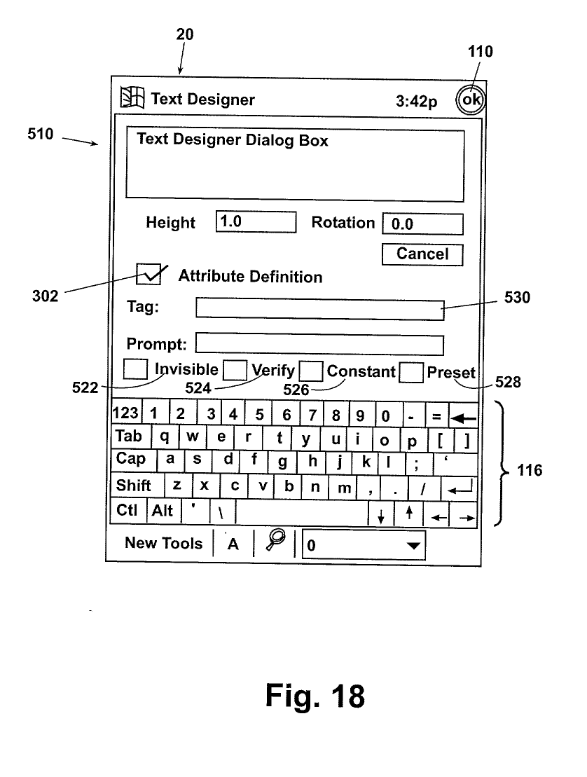

This tool creates a text attribute for use within blocks. Attributes are storage locations within the blocks that allow the user to update the text information without having to redefine the block. The steps required to create attribute definitions are similar to creating text. As seen in FIG. 11, the user first picks the Text Tool 104dd, which opens the Text Designer dialogue box 300. Then, the user toggles the Attribute Definition 302 to ON by checking the box 304. As seen in FIG. 18, the Attribute Definition 302 values appear in the Property dialogue box 520. The user may then supply a Tag 530 by using the stylus 32 to enter the name from the alphanumeric keypad 116. The user then supplies the prompt that should be displayed when the user accesses the block with this definition in it.

The user then checks the desired mode for the attribute definition to ON for either the Invisible 522, Verify 524, Constant 526, or Preset 528 modes. The Invisible mode 522 specifies the attribute values that will not be displayed when the user inserts a block. The Constant mode 526 fixes the attributes value for block insertions. The Verify mode 524 requires the user to verify that the attribute value is correct when the user inserts the block. The Preset mode 528 sets the default attribute value when the user inserts the block. Once the desired mode is selected, the user clicks on the OK button 110 in the header bar 100 to add the attribute object to the drawing.

Exploding Tool 104ff:

This tool allows the user to explode (ungroup) objects one level deep to their base object in a drawing that comprises more than one object (e.g., both blocks and polylines contain multiple objects, such as items and lines, respectively). To explode a polyline or block, the user first opens a drawing in the window 102 that contains the block to be exploded. Then, the user picks the grouping to be exploded by selecting it with the stylus 32. Then, the user picks the Explode Tool 104ff to explode the block into its separate objects.

Editing Tools

The editing tools provide flexibility in controlling and changing objects that the user has created in the drawings. The Object Property dialogue box (FIG. 21), which displays the properties of a selected object, can quickly edit lines, circles, arcs, text, polylines, rotation, blocks, and block attributes. Note that editing commands are not persistent like drawing commands; once the user picks an editing tool and performs the editing task, the user is promptly returned to the tool that was active when the user first initiated the editing task. In a typical editing operation, the user may first open a drawing to be edited, then click on the Select Tool 104l to pick an item to edit. To add additional items to the selection set, the user activates the keypad 116 ON, then turns the SHIFT key ON, and then continues to select item to be edited. Selecting the selected objects removes them from the selection set. The user may then click on an editing tool and pick the selected item to execute a specific editing operation.

Delete Tool 104n:

The user may delete a selected item by first selecting the Delete Tool 104n, then selecting the item to be deleted.

Move Tool 104o:

This tool moves selected items a specific distance and direction as defined by two points. To move items, the user first selects the items to be moved and then selects the Move Tool 104o. The user then selects two points on the window 102 to define the distance and direction the selection will be moved. The first selected point acts as the base reference point, while the second selected point defines the move distance and direction. If the user selects multiple items to move at one time, they can be moved together without any change in the relative positions of the multiple items.

The CAD software provides two methods for selecting the two points. The first method, using the Pick Points Tool 104e, simply involves selecting two points visually in the window. After the user selects the Move Tool 104o, the user selects a first point as a reference point with the stylus 32 using the place/move/lift method explained above. The user then selects a second point with the stylus 32 to define the item's new position. To help the user visualize both the original and new positions for the moved item, the window 102 may display the original item position in shadow (e.g., with a dotted line) and the new item position with a solid line. Once the user confirms the new item position, the original item position disappears from the window 102.

If the user wants more precise control over the new item position, the second method involves using the Set Points Tool 104f with the Move tool 104o. To move items using the Set Points Tool 104f, the user first selects the entities to move and then pick the Move Tool 104o in the manner explained above. Next, the user selects the base point with the stylus 32. To select the second point corresponding to the new item location, the user then selects the Set Points Tool 104f, which opens the Set Second Point dialogue box 200a. The user then selects values corresponding to new position. In one embodiment, the user selects the new position by entering values in Angle and Distance text boxes 220a, 221a using the stylus 32 and numeric keypad 212a. However, the user may also use the Pick Angle button 206a to set the Angle by selecting two points on the window 102. The user may also use the Pick Distance button 208a to set the distance by picking two points from the window 102. Selecting the OK button 110 in the header bar 100 closes the dialogue box 200a and executes the move.

Copy Tool 104p:

This tool allows the user to copy selected items by a distance and direction defined by two picked points on the window 102. After the user selects the Copy Tool 104p, the user can enter two points defining the distance and direction corresponding to the position of the copied item. The user may select multiple items that can be copied together while maintaining their relative positions with respect to each other. When performing a copy command, the first selected point acts as the base reference point for copying the objects, while the second selected point defines the distance and direction for the copied items.

The general process for copying items is the same as for moving items and will therefore not be repeated here. As with the Move Tool 104o described above, the user can copy objects with either the Pick Points Tool 104e or the Set Points Tool 104f. The main difference is that the copied items appear in both the original position and the new position after the Copy Tool 104p executes the copy function.

Rotate Tool 104q:

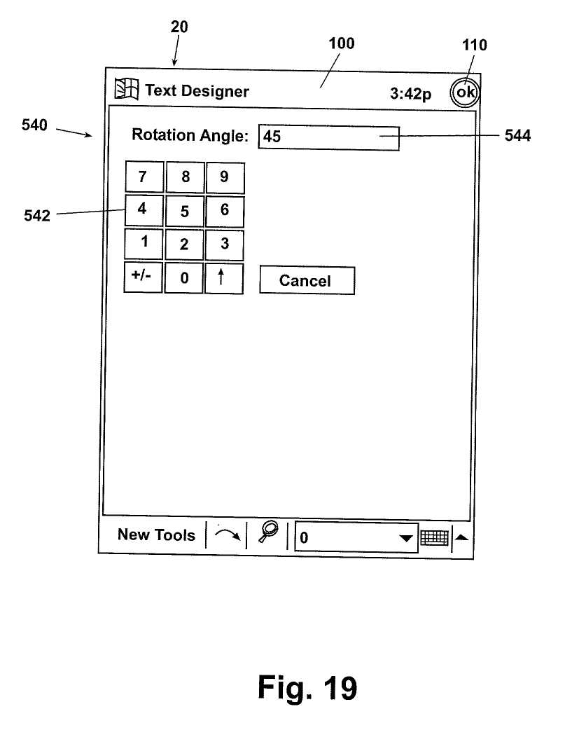

This tool allows the user to rotate selected items in the window 102. To use this tool, the user first selects the Select Tool 104l to choose the items to be rotated, and then selects the Rotate Tool 104q, which opens the Rotation Angle dialogue box 540 seen in FIG. 19. The user then selects a base point about which the item will be rotated and enters an angle value in Rotation Angle text box 544. In one embodiment, the Rotation Angle is measured counter-clockwise around the base point. Selecting the OK button 110 in the header bar 100 closes the dialogue box 540 and executes the rotation about the specified base point at the specified angle value.

Trimming Entities 104r:

This tool allows the user to trim a displayed item. The actual object that can be used as a cutting edge can include a line, arc, or circle, depending on the desired shape of the final trimmed boundary. The Trim Tool 104r also allows the user to select multiple cutting edges before the user trims any items.

To trim an item in the drawing, the user first selects the Trim Tool 104r and then selects what shape will be used as the cutting edge or edges (e.g., a line, arc, circle, etc.). Next, the user selects the item to be trimmed and the portion to be cut. As the user moves the stylus 32 on the item, the trimmed portion disappears from the display. As with all the other tools described above, selection can be conducted using the stylus 32 and the place/move/lift process.

Extend Tool 104s:

The Extend Tool 104s allows the user to edit items that could have common boundary edges by expanding the item to reach the intended boundary. Valid boundary edges include lines, arcs, and circles, similar to the Trim Tool 104r. To edit common boundary edges, the user selects the Extend Tool 104s and then selects the item that will act as the boundary edge. The user then selects the item to be expanded. After the user executes the Extend Tool 104s, the expanded item will reach the boundary of the item acting as the boundary edge.

Offset Tool 104t:

This tool allows the user to copy a selected item at a distance from the original item. The original item remains in its original position after the offsetting process. The type of item being offset dictates how the new offset item is created. Valid offset objects includes lines, arcs and circles.

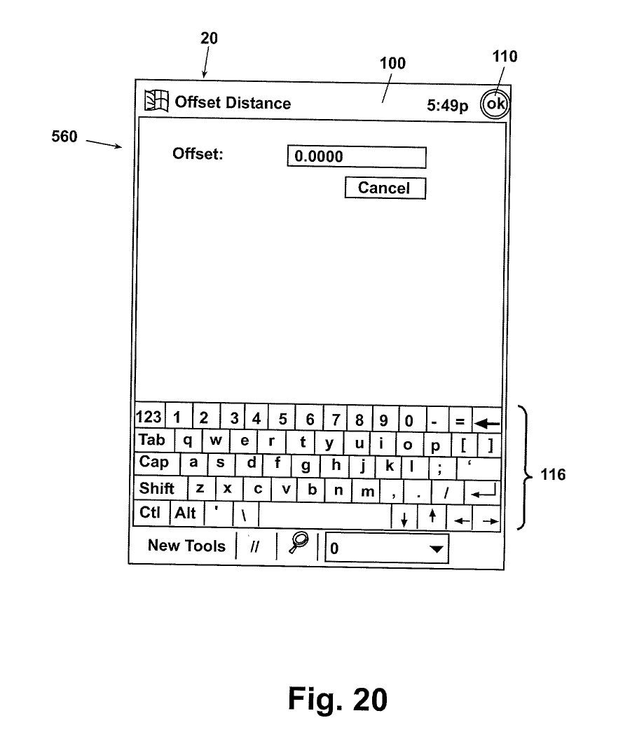

To offset lines, identical parallel copies are created at a distance that the user defines in the Offset dialogue box 560 shown in FIG. 20. For circles and arcs, the Offset Tool 104t creates concentric copies scaled by a selected factor based on the distance entered in the Offset text box 562. The center of the arc or circle is the base point for the scaling.

To perform an offset, the user first selects the item to be offset using the Select Tool 104l and then selects the Offset Tool 104t, which opens the Offset dialogue box 560. The user then supplies an offset distance in the Offset text box 562 with the alphanumeric keypad 116. Selecting the OK button 110 in the header bar 100 returns the device 10 to the window 102. The user then selects a portion (e.g., line, arc, circle) of the selected item to offset on the window 102. The user then picks the direction of the offset to complete execution of the Offset Tool 104t.

Layers Tool 104j:

This Layers Tool allows the user to both draw and edit the layers on a drawing. The tool is explained in the Drawing Tools section above.

Change Layer Tool 104k:

This tool allows the user to move selected items from their existing layer to the current layer. To change a layer, the user first select the drawing items to be changed. Using the Current Layer Pull-down List 152, the user may set the current layer to dictate where the selected items will be placed. Then, the user selects the Change Layer Tool 104k to move all of the selected items to the selected current layer.

Object Property Page Tool 104m:

This tool displays the properties of a selected object for inquiry and editing. The user may view and/or edit, for example, lines, circles, arcs, text, polylines, rotation, blocks, and block attributes. To display or edit the properties of an item, the user will typically first open a drawing in the device 10 and then select an item to view and/or edit. The user selects the Object Property Page Tool 104m, which opens the Object Property dialogue box 580, as seen in FIG. 21, to display an entity property box. The user can select a property 582 to edit, displaying other dialogue boxes, list boxes, or the alphanumeric keypad 116 if needed to carry out the desired editing functions. Selecting the OK button 110 in the header bar 100 closes the dialogue box 580 and updates the selected item to reflect the edits. The Pick Points 104e and Set Points Tools 104f may be used to change properties as well. Note that for all of the examples described below, the specific format and interface for the dialogue box is not important as long as the user can view and edit the properties relevant to a given item.

As a example, the dialogue box 580 shown in FIG. 21 displays various properties for a circle, such as a center point 588, the radius 590, and area 592, which has respective text boxes 594, 596, and 598. In this example, the user can change the Layer 584 and Color property 586 for any selected entity. The user may select the property to display a list box showing the available layers 584 or colors 586 that the user may choose. Once the user selects a new layer 584 or color 586 and selects the OK button 110 in the header bar 100, the property for the selected item changes.

Basic properties for entities such as lines, arcs, circles, text, polylines, blocks, and block attributes contain unique properties that can also be changed through the Object Property Page. Any desired changes can be conducted through the dialogue boxes using the stylus 32 and/or the alphanumeric keypad as well as the Pick Points Tool 104e and the Set Points Tools 104f. Several examples will be described below.

For a line, the Object Property Page Tool 104m can change the start and the end points. The property page is hidden when the user selects the value in the Start or End Point text box. Using the Pick Points 104e or Set Points Tools 104f, the user can change the value of the end point. For both arcs and circles, the Object Property Page Tool 104m can reset the center point, radius, start angle, and/or end angle by selecting the appropriate text box in the arc's corresponding property page.

For text, the user can edit a text string by selecting a Text Value text box in the text's corresponding property page. The user may also may reset the insertion point on screen by using the Pick Points 104e or Set Points Tool 104f. The text's rotation, height, and width can also be reset by selecting a corresponding text box. The user can also reset the horizontal and vertical justification via a pull-down menu to choose the desired value.

For polylines, the user can update polyline vertices by choosing the appropriate Vertex text box. The area bounded by the polyline can be displayed in this box. In one embodiment, area can be displayed both as square units and square units divided by 144 (square feet). The user can reset the vertex point from the screen using the Pick Points 104e or Set Points Tool 104f.

For text blocks, the user can pick an Insertion Point text box to change the text insertion point. The user may reset the insertion point on the screen 20 by using the Pick Points 104e or Set Points Tool 104f. The user can reset the rotation, X-scale, or Y-scale by selecting the respective text box. The alphanumeric keypad 116 opens so that the user may enter values with the stylus 32 pen 32.

For block attributes, the user can update attribute values, when detected within a block, by picking the attribute text box that is to be changed. The user can provide a new value that will be updated when the OK button 110 in the header bar 100 is selected.

Inquiry Tools

Inquiry Tools allow the user to manipulate drawings to enhance appearance and usability. In one embodiment, Inquiry Tools allows the user to pan, zoom, see a previous view, show the entire drawing, view properties of drawn objects, and measure distances. Examples of these possible tools are described below. As with all the tools described above, Inquiry Tools are not limited to those described below, and the invention can incorporate less or more than all of the tools described below.

Pan Tool 104a:

This tool allows the user to slide the drawing across the screen in the same direction that the user moves the stylus 32. When the stylus 32 is lifted from the window 102, the drawing is refreshed at the new location. To pan the drawing, the user selects the Pan Tool 104a, places the stylus 32 on the window 102, and move the stylus 32 to view a different portion of the drawing.

Zoom Window Tool 104c:

This tool allows the user to zoom to a selected portion of the drawing for closer viewing. To define a region to be viewed more closely by zooming, the user specifies opposite comers of a rectangular zoom window with the stylus 32. More particularly, the user first selects the Zoom Window Tool 104c and then touches the stylus 32 to the display 20 to set one comer of the zoom window. The user then slides the stylus 32 to another position on the window 102 without lifting the stylus 32 from the window 102 until the zoom window is the desired size and shape. Once the user lifts the stylus 32 from the window 102, the window display resets itself by zooming into the region defined by the rectangular zoom window.

Zoom Previous Tool 104b:

The Zoom Previous Tool 104b allows the user to return to the previous view before the current zoom view by simply selecting the tool.

Zoom Extents Tool 104d:

The Zoom Extents Tool 104d allows the user to zoom out into a drawing view that displays all items in the drawing. The user may display all items in the drawing by simply selecting the tool.

Object Property Page Tool 104m:

This tool 104m displays the properties of a selected item for both inquiry and editing and also allows the user to view and edit lines, circles, arcs, text, polylines, rotation, blocks, and block attributes. The operation of the Object Property Page Tool 104m is discussed above in the Editing Tool section.

Measure Tool 104g;

This tool allows the user to display the distance between two selected points on the window 102. To use this tool, the user selects the Measure Tool 104g, places the stylus 32 on the window 102, and moves the stylus 32 across the window 102 to the desired location for the first point. The first point is recorded when the user lifts the stylus 32 pen. The user then repeats this process to select the second point. A distance display updates in real-time while the user moves the stylus 32 to position the second point.

As a result, the stability and operating convenience provided by the invention permits accurate design revisions on a project site, in the field, on the manufacturing floor, or in any environmnent where physical stability and/or ideal operating conditions for conventional PDAs may not exist. Engineers, space planners, and architects all can potentially incorporate the device for on-site plan viewing and modification.

Further, the inventive system allows CAD drawings to be modified while the user is away from a PC by converting the drawings into a format that can be displayed and modified in a portable device 10. Using filters to convert the CAD files and/or script files in the portable device to the native format used by the PC allows the invention to function regardless of the specific CAD software vendor. This flexibility also allows downloading of data from multiple portable devices into a single database.

In one embodiment, the device 10 is compatible with and complements a central PC desktop system running. for example, on a Windows based IBM-PC or Sun Microsystems processor. The device 10 may run on Windows CE 2.11 or higher and should be compatible with various commercially available CAD software, such as AutoCAD, DWG, and DXF. Of coarse, the inventive system can be implemented with any operating system and any CAD software without departing from the scope of the invention as defined in the claims

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. A portable computing device, comprising:
a user interface having a touch-sensitive display that detects contact between an input device and the display;
a processor; and
a memory that stores a data selection, wherein the processor detects a position of the input device when the input device is removed from the display and stores the data selection corresponding to the position in the memory.

2. The portable computing device of claim 1, wherein the input device is a stylus.

3. The portable computing device of claim 1, wherein the user interface further comprises at least one selected from the group consisting of at least one directional button, a rotary switch, and a rocker arm.

4. The portable computing device of claim 3, wherein the rotary switch is movable in both a rotary direction and in a linear direction.

5. The portable computing device of claim 1, further comprising a data communication port for importing data to and exporting data from the memory.

6. The portable computing device of claim 5, wherein the data communication port is at least one selected from the group consisting of a wireless data port and a wired data port.

7. The portable computing device of claim 1, further comprising a portable computer aided design (CAD) program stored in the memory.

8. The portable computing device of claim 7, wherein the portable CAD program complements a desktop CAD program on a personal computer such that data can be exchanged between the portable CAD program and the desktop CAD program.

9. The portable computing device of claim 8, wherein an original file prepared with the desktop CAD program is downloaded to the memory of the portable computing device for modification through the portable CAD program.

10. The portable computing device of claim 9, wherein the original file is in a native format and the processor converts the original file from the native format to a portable format.

11. The portable computing device of claim 9, wherein the processor records changes made to the original file in the portable computing device in a script file.

12. The portable computing device of claim 7, wherein the portable CAD program comprises at least one selected from the group consisting of drawing tools, block tools, editing tools, and inquiry tools.

13. A computer aided design (CAD) system, comprising:
a main computer that runs a desktop CAD program;
at least one portable computing device that runs a portable CAD program; and
a communication link between the main computer and the at least one portable computing device, wherein the portable CAD program and the desktop CAD program are complementary to allow data to be exchanged between the main computer and the portable computing device.

14. The system of claim 13, wherein the portable CAD program comprises at least one selected from the group consisting of drawing tools, block tools, editing tools, and inquiry tools.

15. The system of claim 13, wherein the portable computing device receives a copy of an original CAD file from the main computer, and wherein changes to the original file made through the portable computing device are stored in a memory in the portable computing device.

16. The system of claim 15, wherein the changes to the copied original file are stored in the memory as at least one of a modified CAD file and a script file.

17. The system of claim 16, wherein the original CAD file is a native format and the at least one of the modified CAD file and the script file is in a portable format, and wherein the system further comprises a filter that converts the copied original CAD file from the native format to the portable format and converts at least one of the modified CAD file and the script file from the portable format to the native format.

18. The system of claim 17, wherein the main computer plays the converted script file against the original CAD file in the main computer to generate a modified CAD file in the native format in the main computer.

19. The system of claim 16, wherein the main computer plays the script file against the original CAD file in the main computer to generate a modified CAD file in the main computer.

20. The system of claim 13, wherein the communication link is at least one selected from the group consisting of a wireless link and a wired link.

21. The system of claim 13, wherein the portable computing device comprises:
a user interface having a touch-sensitive display that detects contact between an input device and the display;
a processor; and
a memory that stores a data selection, wherein the processor detects a position of the input device when the input device is removed from the display and stores the data selection corresponding to the position in the memory.

22. The system of claim 21, wherein the input device for the portable computing device is a stylus.

23. The system of claim 21, wherein the user interface for the portable computing device further comprises at least one selected from the group consisting of at least one directional button, a rotary switch, and a rocker arm.

24. The system of claim 23, wherein the rotary switch on the portable computing device is movable in both a rotary direction and in a linear direction.

25. A method for entering data on a portable computing device having a memory, a processor, and touch-sensitive screen, the method comprising:
detecting the placement of an input device on the screen; and
saving data corresponding to a position of the input device when the input device is lifted from the screen.

26. The method of claim 25, further comprising:
detecting a position change of the input device before the input device is lifted from the screen, wherein the saving step saves data corresponding to the changed position.

27. The method of claim 25, further comprising:
importing an original file from a main computer into a memory in the portable computing device;
detecting modifications of the original file made through the portable computing device; and
storing the modifications to the original file.

28. The method of claim 27, wherein the portable computing device has a computer aided design (CAD) program stored in the memory.

29. The method of claim 28, wherein the storing step stores the modifications as at least one of a modified CAD file and a script file.

30. The method of claim 29, wherein the original file is an original CAD file in a native format and at least one of the modified CAD file and the script file is in a portable format, and wherein the method further comprises:
converting the original file from the importing step from the native format to the portable format;
converting the at least one of the modified CAD file and the script file from the portable format to the native format; and
loading the at least one of the modified CAD file and the script file to the main computer.

31. The method of claim 28, further comprising:
generating at least one of a plurality of drawing tools, block tools, editing tools, and inquiry tools.

32. The method of claim 31, wherein the tools include the step of automatically repositioning a drawing on the screen responsive to movement of the input device.

33. The method of claim 31, further comprising:
generating a user interface for entering a base point and at least one of a distance and a direction relative to the base point.
